(19) United States
(12) Patent Application Publication
(10) Pub. No.: US 2026/0225597 A1
(43) Pub. Date: Aug. 6, 2026

(54) INFORMATION PROVIDING APPARATUS

(71) Applicant: Honda Motor Co., Ltd., Tokyo (JP)

(72) Inventor: Masayuki Sato, Saitama (JP)

(21) Appl. No.: 19/455,270

(22) Filed: Jan. 21, 2026

(30) Foreign Application Priority Data
Feb. 3, 2025 (JP) 2025-016203

(51) Int. Cl. B60W 40/09

(52) U.S. Cl. CPC B60W 40/09; B60W 2420/403; B60W 2540/30

(57) ABSTRACT

Information providing apparatus includes: a sensor detecting behavior of a vehicle, and an in-vehicle device that: recognizes a surrounding situation of a vehicle; estimates a state of a driver of the vehicle; analyzes a driving action of the driver; determines whether the driving action corresponds to a first specific event in which a predetermined operation is performed on a driving operation member to avoid danger predicted by the driver, or a second specific event in which the predetermined operation is performed on the driving operation member to avoid danger without the driver making a prediction; selects second content according to the driving action when the driving action corresponds to the second specific event, and selects first content according to a factor of the predetermined operation when the driving action corresponds to the first specific event; and provides the first or second content to the driver.

### CROSS-REFERENCE TO RELATED APPLICATION

This application is based upon and claims the benefit of priority from Japanese Patent Application No. 2025-016203 filed on Feb. 3, 2025, the content of which is incorporated herein by reference.

### BACKGROUND OF THE INVENTION

### Field of the Invention

The present invention relates to an information providing apparatus that provides content regarding a driving action of a driver.

### Description of the Related Art

As this type of technology, there is known a technology in which, in a case where event information regarding a near miss is plotted on a map, if a similar case occurs at a similar place, similar event information is not plotted to that place (JP4674187B2).

If information of similar events is simply not provided as in the conventional technology, information useful for the driver is not provided. It is expected that useful information provision to the driver greatly contributes to traffic safety.

### SUMMARY OF THE INVENTION

An aspect of the present invention is an information providing apparatus, including: a sensor configured to detect a behavior of a vehicle; and an in-vehicle device including a processor and a memory coupled to the processor. The in-vehicle device is configured to perform: recognizing a surrounding situation of the vehicle; estimating a state of a driver of the vehicle; analyzing a driving action of the driver based on the behavior of the vehicle, the surrounding situation, and the state of the driver; determining whether the driving action corresponds to a first specific event in which a predetermined operation is performed on a driving operation member to avoid a danger predicted by the driver, or a second specific event in which the predetermined operation is performed on the driving operation member to avoid the danger without the driver making a prediction; selecting a second content according to the driving action in a case where it is determined that the driving action corresponds to the second specific event, while selecting a first content according to a factor of the predetermined operation in a case where it is determined that the driving action corresponds to the first specific event; and providing the first content or the second content to the driver.

### BRIEF DESCRIPTION OF THE DRAWINGS

The objects, features, and advantages of the present invention will become clearer from the following description of embodiments in relation to the attached drawings, in which:

FIG. 1A is a schematic diagram illustrating an example of an information providing system;

FIG. 1B is a schematic diagram illustrating an example of a vehicle equipped with an IVI system;

FIG. 2A is a block diagram illustrating a configuration of a main part of an in-vehicle device;

FIG. 2B is a block diagram illustrating a configuration of a main part of a vehicle sensor group and a vehicle interior camera;

FIG. 2C is a block diagram illustrating a configuration of a main part of an input device and an output device; and

FIG. 3 is a flowchart describing an example of information providing processing by a program.

### DETAILED DESCRIPTION OF THE INVENTION

### <Overview>

An information providing apparatus according to the invention provides, to a driver of a vehicle, content information for safely traveling through various dangerous scenes encountered in a traffic scene. The content information is a teaching material for introducing a situation in which an accident or the like is likely to occur by showing various cases in association with a time zone, a day of the week, a state of weather, and the like in which the vehicle travels at an intersection, a residential area, an urban area, a parking lot, and the like, and causing the driver to perform driving action for avoiding danger, and includes video content and/or sound content.

In the embodiment, an information providing apparatus is exemplified as one of functions of an In-Vehicle Infotainment (IVI) system provided in an own vehicle. In a case where the information providing apparatus detects that driving action for avoiding danger is performed in the traveling own vehicle based on detection information or the like by a sensor or the like provided in the own vehicle, the information providing apparatus analyzes the driving action and provides different content information to the driver based on an analysis result.

The information of the analysis result obtained by the information providing apparatus may be sent to an external device via a public communication network as information for each driver and managed by the external device. An information providing system including such an information providing apparatus, a public communication network, and an external device will be described in more detail with reference to the drawings.

### <Configuration Example of Information Providing System>

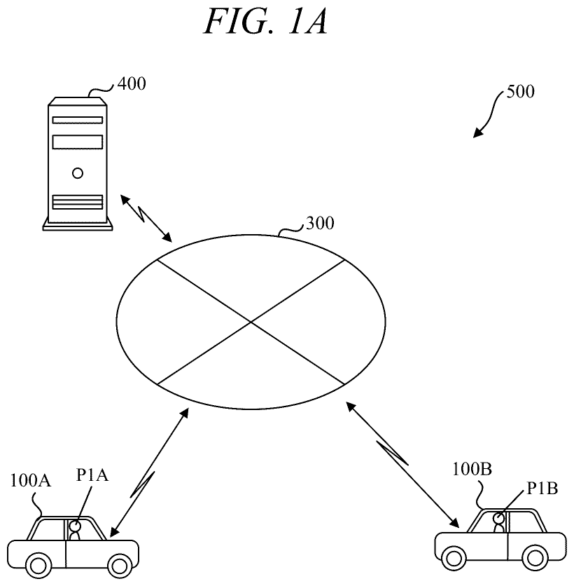

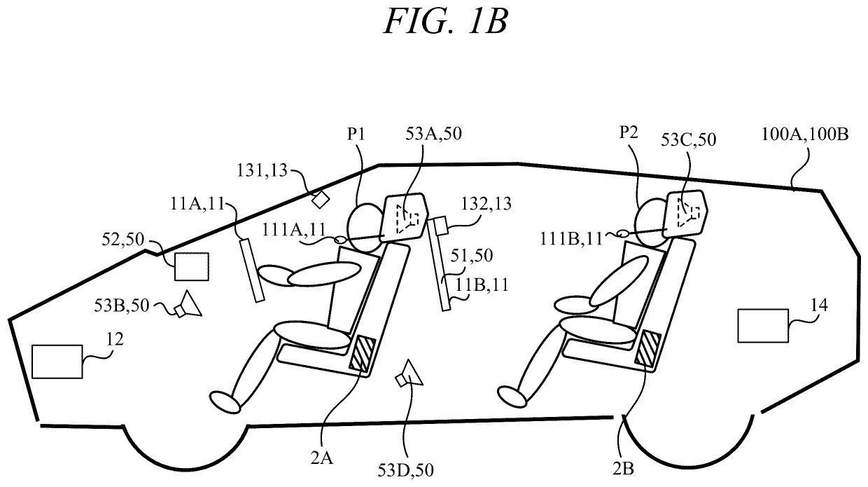

FIG. 1A is a schematic diagram illustrating an example of an information providing system 500. In the embodiment, a system including a vehicle 100A driven by a driver P1A, a vehicle 100B driven by a driver P1B, a public communication network 300, and a server device 400 is exemplified as the information providing system 500. In each of the vehicles 100A and 100B, the driving action is evaluated by each information providing apparatus.

### <Configuration in Vehicle>

FIG. 1B is a schematic diagram illustrating an example of the vehicle 100A equipped with an IVI system including an information providing function as one of the functions. It is assumed that the vehicle 100A and the vehicle 100B have the same configuration. Therefore, in the following description, the vehicles 100A and 100B are referred to as a vehicle 100, the drivers P1A and P1B are referred to as a driver P1, and passengers P2A and P2B are referred to as a passenger P2.

The IVI system includes an in-vehicle device 14, a vehicle sensor group 12, a display unit 51, a projection unit 52, and voice reproduction units 53A to 53D constituting an output device 50, operation detection units 11A and 11B and microphones 111A and 111B constituting an input device 11, a front seat camera 131 and a rear seat camera 132 constituting a vehicle interior camera 13, a terminal 2A used by the driver P1 in a front seat of the vehicle interior, and a terminal 2B used by the passenger P2 in a rear seat of the vehicle interior. FIG. 1B illustrates a case where the driver P1 and the passenger P2 are seated in the vehicle interior.

The in-vehicle device 14 and the terminals 2A and 2B are configured to be able to perform, for example, Ultra-Wide Band (UWB) wireless communication. The UWB wireless communication is a communication system that enables highly accurate positional measurement using an ultra-wide band frequency bandwidth. In the embodiment, the positions of the terminals 2A and 2B in the vehicle interior can be detected with high accuracy.

The in-vehicle device 14, the output device 50, the input device 11, the vehicle sensor group 12, and the vehicle interior camera 13 are configured to be able to perform wired communication by a Controller Area Network (CAN) or the like.

The terminals 2A and 2B are, by way of example, smartphones or the like used by each of the driver P1 and the passenger P2. The terminals 2A and 2B may be held by a holder (not illustrated) installed on a seat on which each person sits.

Although two terminals 2A and 2B are illustrated as terminals used by the driver P1 and the passenger P2, the actual number of terminals varies depending on the number of occupants, and may be four if there are four occupants. In addition, the number of cameras constituting the vehicle interior camera 13, the number of operation detection units and microphones constituting the input device 11, and the number of display units, projection units, and voice reproduction units constituting the output device 50 may also be appropriately changed according to the number of occupants.

In the IVI system, if a button corresponding to a danger prediction training is touch-operated from among a plurality of menu buttons (may be referred to as icons) displayed on the output device 50, or if a voice corresponding to the danger prediction training is input from the microphones 111A and 111B constituting the input device 11 in a state where an operation menu screen (not illustrated) is projected or displayed on the output device 50 (projection unit 52, display unit 51), the in-vehicle device 14 starts an operation as the information providing apparatus 200.

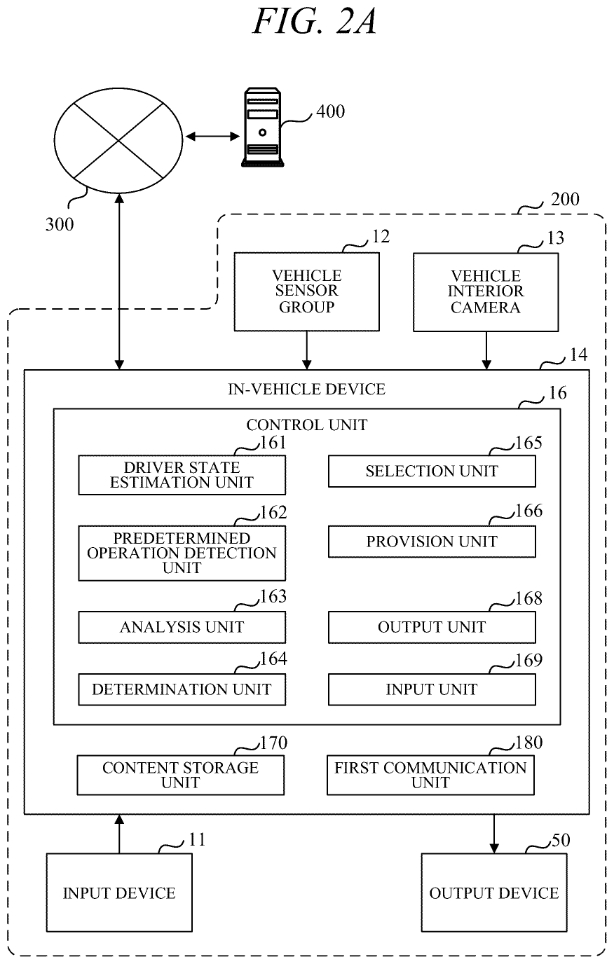

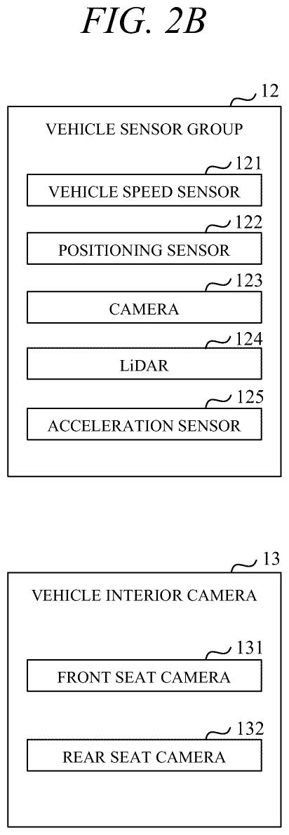

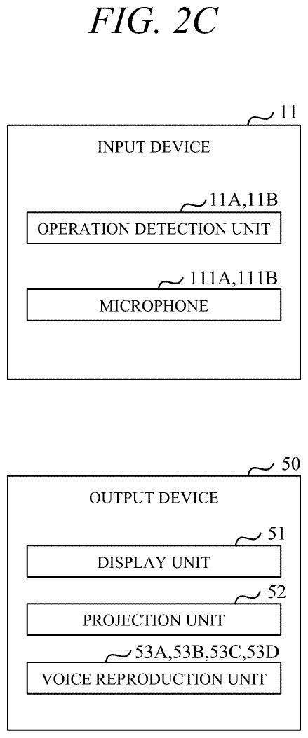

Hereinafter, the function of the in-vehicle device 14 as the information providing apparatus 200 will be mainly described. FIGS. 2A to 2C are diagrams illustrating a configuration example of each unit in FIG. 1B.

### <In-vehicle Device>

FIG. 2A is a block diagram illustrating a configuration of a main part of the in-vehicle device 14. The in-vehicle device 14 includes a control unit 16 that substantially functions as a Micro Processing Unit (MPU) of the IVI system, and reads and executes a predetermined program stored in a storage unit (not illustrated) in the control unit 16 to perform various information processing, control processing, and the like necessary in the in-vehicle device 14.

In FIG. 2A, the in-vehicle device 14 includes the control unit 16, the content storage unit 170, and the first communication unit 180. In a case of starting the operation as the information providing apparatus 200, the control unit 16 reads and executes an application program for the information providing apparatus 200 stored in a storage unit in the control unit 16, thereby performing various types of information processing, control processing, and the like necessary for the information providing apparatus 200.

The control unit 16 includes, as a functional configuration for providing content information, a driver state estimation unit 161, a predetermined operation detection unit 162, an analysis unit 163, a determination unit 164, a selection unit 165, a provision unit 166, an output unit 168, and an input unit 169.

Note that, in the embodiment, as an example, when the driver P1 and the passenger P2 get on the vehicle 100, the in-vehicle device 14 may speak to the driver P1 and the passenger P2 via the voice reproduction units 53A to 53D constituting the output device 50, the microphones 111A and 111B constituting the input device 11 may collect voices (e.g., introducing one's own name) responded by the driver P1 and the passenger P2, and the front seat camera 131 and the rear seat camera 132 constituting the vehicle interior camera 13 may photograph the driver P1 and the passenger P2.

The in-vehicle device 14 associates (may be said to relate) the faces of the driver P1 and the passenger P2, the names of the driver P1 and the passenger P2, and the frequency components of the voice uttered by the driver P1 and the passenger P2, so that it is possible to identify the faces, the names, and the voices of all the occupants in the vehicle interior.

The in-vehicle device 14 manages the information regarding the driving action acquired as the information providing apparatus 200 as driving information of the driver P1 seated on the driver's seat.

### (Driver State Estimation Unit)

The driver state estimation unit 161 estimates the state of the driver P1 who is driving based on, for example, the image of the driver P1 acquired by the vehicle interior camera 13. The reason for estimating the state of the driver P1 is to capture a state that may possibly lead to an accident. That is, the driver P1 estimates a “nervous” state or a “startled” state, that is, a so-called near miss state.

In addition to the image acquired by the vehicle interior camera 13 or instead of the image acquired by the vehicle interior camera 13, the state of the driver P1 who is driving may be estimated by using biological information (e.g., heart rate, blood pressure, body temperature, sweating, etc.) acquired by a biological sensor (vital sensor) provided in the terminal 2A used by the driver P1. The biological sensor may be configured, for example, such that another device (not illustrated) such as a smart watch is combined with the terminal 2A, and functions are shared between the other device and the terminal 2A.

### (Predetermined Operation Detection Unit)

For example, the predetermined operation detection unit 162 detects a so-called sudden brake operation and an abrupt steering operation as predetermined operation on a driving operation member based on a behavior of the vehicle 100 detected by the vehicle sensor group 12 serving as a detection unit, an operation amount on a brake pedal serving as a driving operation member detected by the vehicle sensor group 12, and an operation amount on a steering wheel serving as a driving operation member detected by the vehicle sensor group 12.

### (Analysis Unit)

The analysis unit 163 analyzes the driving action of the driver P1 based on the behavior of vehicle 100 detected by vehicle sensor group 12, the surrounding situation of vehicle 100 recognized by control unit 16 serving as a recognition unit based on the detection data by the vehicle sensor group 12, and the state of driver P1 estimated by driver state estimation unit 161.

For example, the combination of the behavior of the vehicle 100 and the surrounding situation of the vehicle 100 is divided into a predetermined number of patterns (e.g., there are various traveling scenes such as an intersection, a residential area, an urban area, and a parking lot, the traveling scenes in association with a traveling time zone, a day of the week, a weather condition, and the like) indicating the relationship between the behavior of the vehicle 100 and the surrounding situation of the vehicle 100, and the relationship between the driving action performed in each pattern, the result of the driving action (presence or absence of sudden deceleration, presence or absence of abrupt steering, magnitude of acceleration, etc.), and the presence or absence of a near miss state is analyzed.

### (Determination Unit)

The determination unit 164 determines whether the driving action analyzed by the analysis unit 163 corresponds to the first specific event or the second specific event. For example, from the driving action of the driver P1, the predetermined operation not caused by the cognition and determination mistake of the driver P1 is determined as the first specific event, and the predetermined operation caused by the cognition or determination mistake of the driver P1 is determined as the second specific event.

More specifically describing, when a danger predicted by the driver P1 actually occurs instead of a simple near miss experience (which may be referred to as a dangerous scene), the determination unit 164 determines that the predetermined operation performed by the driver P1 on the driving operation member to avoid danger is the first specific event. On the other hand, when a danger occurs without any prediction by the driver P1, the determination unit 164 determines that the predetermined operation performed by the driver P1 on the driving operation member to avoid danger is the second specific event.

Specifically, in a case where the vehicle has already decelerated or stopped accelerating before the predetermined operation on the driving operation member, the predetermined operation is determined as the first specific event since it is not caused by the cognition and determination mistake of the driver P1. On the other hand, in a case where the vehicle has not decelerated or has continued to accelerate before the predetermined operation on the driving operation member, the predetermined operation is determined as the second specific event since it is caused by the cognition or determination mistake of the driver P1.

### (Selection Unit)

The selection unit 165 selects content of a group related to an analysis result of the analysis unit 163 from among a plurality of pieces of content prepared in advance.

That is, in a case where the driving action analyzed by the analysis unit 163 corresponds to the first specific event, in other words, in a case where sudden brake operation or abrupt steering operation not caused by cognition and determination mistake of the driver P1 is performed, the selection unit 165 extracts a driving action to be learned (which may be referred to as training) from the driving action analyzed by the analysis unit 163, and selects content for causing the extracted driving action to be learned as a driving action for avoiding danger from among a plurality of pieces of content prepared in advance as the first content.

More specifically describing, the first content is content that is generated based on a driving scene different from a driving scene (including a dangerous scene) at the time the predetermined operation detection unit 162 determines that the first content corresponds to the predetermined operation as a subject and has a common factor of the predetermined operation. The fact that the factors of the predetermined operation are common means that the factors are common in terms of whether the factor is an internal factor or an external factor. The internal factor is a factor of the driver P1 himself/herself such as distraction, inexperience, and arrogance of the driver P1. Furthermore, the external factor is a factor other than the driver P1, such as the action (jumping out, interrupting, aggressive driving, etc.) of other traffic participants or the traffic environment (state of the vehicle 100, weather, and road condition) and the like.

That is, in a case where the driving action analyzed by the analysis unit 163 corresponds to the second specific event, in other words, in a case where sudden brake operation or abrupt steering operation caused by cognition or determination mistake of the driver P1 is performed, the selection unit 165 extracts a driving action to be learned (which may be referred to as training) from the driving action analyzed by the analysis unit 163, and selects content for causing the extracted driving action to be learned as a driving action for avoiding danger from among a plurality of pieces of content prepared in advance as the second content. The second content refers to content generated using a dangerous scene similar to the dangerous scene at the time the predetermined operation detection unit 162 determines as corresponding to the predetermined operation.

### (Provision Unit)

The provision unit 166 provides the content selected by the selection unit 165 to the driver P1. The content provided to the driver P1 can be viewed by the driver P1 in the vehicle interior.

Note that the provided content may be video content (moving image, still image, text display, icon display, graphic display, etc.) or sound content. The sound content includes voice content and music content.

### (Output Unit)

The output unit 168 outputs a video signal to the output device 50 in a case of reproducing video content according to an instruction from the driver P1. As a result, the video based on the video signal output from the output unit 168 is displayed on the display unit constituting the output device 50.

In addition, the output unit 168 outputs a reproduction signal to the output device 50 in a case of reproducing sound content according to an instruction from the driver P1. As a result, the voice based on the reproduction signal output from the output unit 168 is reproduced by the speaker or the like constituting the output device 50.

### (Input Unit)

The input unit 169 inputs voices uttered by the driver P1 and the passenger P2. More specifically, the voice signal of the driver P1 collected by the microphone 111A is input. Furthermore, the voice signal of the passenger P2 collected by the microphone 111B is input.

### (Content Storage Unit)

The content storage unit 170 stores content information given to the driver P1. The content information includes information of a plurality of pieces of first content generated in advance with a plurality of dangerous scenes as the subject and information of a plurality of pieces of second content.

Upon receiving the provision of the content, the driver P1 can view only the provided content from among the contents stored in the content storage unit 170.

The provision unit 166 normally selects content to be provided to the driver P1 from among the contents stored in the content storage unit 170. Note that, for example, in order to enrich the types of content, not only the content stored in the content storage unit 170 but also content acquired from an external device such as the server device 400 via the public communication network 300 may be provided to the driver P1.

### (First Communication Unit)

The first communication unit 180 includes a short-range wireless communication module (not illustrated) that performs wireless communication with the terminals 2A and 2B and a wired communication module (not illustrated) that performs wired communication by CAN or the like. The UWB wireless communication system described above may be adopted for the short-range wireless communication module.

FIG. 2B is a block diagram illustrating a configuration of a main part of the vehicle sensor group 12 and the vehicle interior camera 13 of the vehicle 100.

### <Vehicle Sensor Group>

The vehicle sensor group 12 includes a vehicle speed sensor 121, a positioning sensor 122, a camera 123, a LiDAR 124, and an acceleration sensor 125. An operation detection sensor (not illustrated) for detecting operations on various driving operators may also be included in the vehicle sensor group 12.

### (Vehicle Speed Sensor)

The vehicle speed sensor 121 detects a vehicle speed of the vehicle 100 and outputs vehicle speed information to the in-vehicle device 14.

(Positioning Sensor)

The positioning sensor 122 detects the current position of the vehicle 100 based on positioning signals from Global Positioning System (GPS) satellites, quasi-zenith satellites, or the like. The positioning sensor 122 outputs a signal indicating the current position to the in-vehicle device 14 as position information.

### (Camera)

The camera 123 photographs the surroundings (surrounding situation) of the vehicle 100. The camera 123 outputs data of a subject image to the in-vehicle device 14 as image information. The camera 123 can capture a still image or a moving image.

### (LiDAR)

The Light Detection And Ranging (LiDAR) 124 performs scanning by changing an irradiation angle of laser light to be emitted, and measures detection of an object, a distance to the object, and the like based on the position information of each detection point. The measurement data is output to the in-vehicle device 14.

### (Acceleration Sensor)

The acceleration sensor 125 detects an acceleration of the vehicle 100 and outputs acceleration information to the in-vehicle device 14.

### <Vehicle Interior Camera>

The vehicle interior camera 13 includes the front seat camera 131 and the rear seat camera 132. The front seat camera 131 photographs the upper body of the driver P1 sitting in the front seat, and outputs data of the subject image to the in-vehicle device 14 as image information. The rear seat camera 132 photographs the upper body of the passenger P2 sitting in the rear seat, and outputs data of the subject image to the in-vehicle device 14 as image information.

FIG. 2C is a block diagram illustrating a configuration of a main part of the input device 11 and the output device 50 of the in-vehicle device 14 of the vehicle 100.

### <Input Device>

The input device 11 includes operation detection units 11A and 11B and microphones 111A and 111B.

### (Operation Detection Unit)

The operation detection unit 11A is operated by the driver P1 in the front seat, and outputs an operation signal to the in-vehicle device 14. The operation detection unit 11A may be configured as a pointing device that interlocks with a projection image projected by the projection unit 52 described later. The operation detection unit 11B is provided on the display surface of the display unit 51. The operation detection unit 11B is operated by the passenger P2 in the rear seat and outputs an operation signal indicating a touch position to the in-vehicle device 14.

### (Microphone)

The microphone 111A collects voice uttered by the driver P1 in the front seat and outputs a voice signal to the in-vehicle device 14. The microphone 111B collects voice uttered by the passenger P2 in the rear seat and outputs a voice signal to the in-vehicle device 14.

<output Device>

The output device 50 includes the display unit 51, the projection unit 52, and the voice reproduction unit 53. The output device 50 is used, for example, for displaying an operation menu screen, reproducing contents, or the like.

### (Display Unit)

The display unit 51 has a screen such as a liquid crystal display, and displays image information based on a display signal output from the in-vehicle device 14. The image information includes the operation menu screen, an image of video content, and the like.

### (Projection Unit)

The projection unit 52 includes, for example, a head-up display (HUD) to be projected on a windshield or the like, and projects image information based on a projection signal output from the in-vehicle device 14. The image information includes the operation menu screen, an image of video content, and the like.

### (Voice Reproduction Unit)

The voice reproduction units 53A to 53D are configured as speakers for reproducing and outputting voice and the like, and reproduce sound content and the like based on a reproduction signal output from the in-vehicle device 14. Note that a voice output unit that outputs content reproduction signal to a headphone (not illustrated) or the like may be provided.

### <Description of Flowchart>

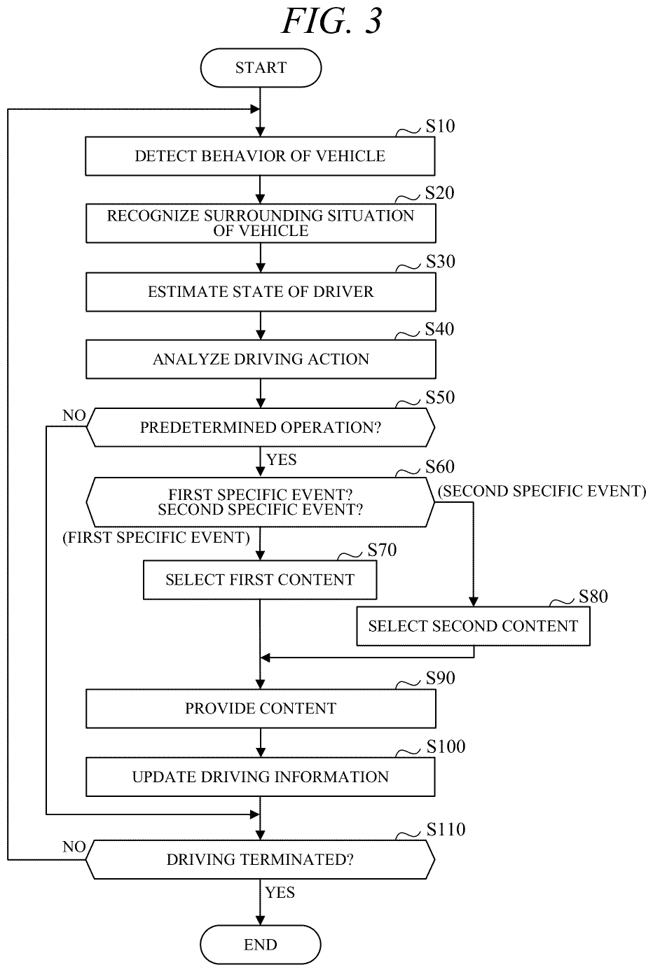

FIG. 3 is a flowchart describing an example of information providing processing by a program executed by the MPU (control unit 16) of the in-vehicle device 14. For example, in a case where the “danger prediction training” button is operated on an operation menu screen (not illustrated), the control unit 16 of the in-vehicle device 14 executes a program for causing the IVI system to function as the information providing apparatus 200.

In S10 (S: processing step) of FIG. 3, the control unit 16 detects the behavior of vehicle 100 using vehicle group 12, and proceeds to S20.

In S20, the control unit 16 recognizes the surrounding situation of the vehicle 100 based on the detection data by the vehicle sensor group 12, and proceeds to S30.

In S30, the control unit 16 estimates the state of the driver P1 who is driving, and proceeds to S40. As described above, the reason for estimating the state of the driver P1 is to capture a state that may possibly lead to an accident, that is, a so-called near miss state.

In S40, the control unit 16 analyzes the driving action of driver P1 based on the behavior of vehicle 100, the surrounding situation, and the estimated state of the driver P1, and proceeds to S50.

In S50, the control unit 16 determines whether or not a predetermined operation has been performed. Specifically, so-called sudden brake operation and abrupt steering operation are predetermined operations on the driving operation member. In a case where the predetermined operation is performed, the control unit 16 makes an affirmative determination in S50 and proceeds to S60, and in a case where the predetermined operation is not performed, the control unit makes a negative determination in S50 and proceeds to S110.

In step S60, the control unit 16 causes determination unit 164 to determine whether the driving action analyzed by the analysis unit 163 corresponds to the first specific event or the second specific event. In a case where the predetermined operation is not caused by the cognition and determination mistake of the driver P1 (that is, corresponds to the first specific event), the determination unit 164 proceeds from S60 to S70. In a case where the predetermined operation is caused by the cognition and determination mistake of the driver P1 (that is, corresponds to the second specific event), the determination unit 164 proceeds from S60 to S80.

In S70, the control unit 16 causes the selection unit 165 to select the first content from among the plurality of pieces of content stored in advance in the content storage unit 170, and proceeds to S90.

In S80, the control unit 16 causes the selection unit 165 to select the second content from among the plurality of pieces of content stored in advance in the content storage unit 170, and proceeds to S90.

In S90, the provision unit 166 of the control unit 16 provides the content selected by the selection unit 165 to the driver P1, and proceeds to S100. In the embodiment, placing the selected content in a state viewable from the driver P1 is referred to as provision.

In S100, the control unit 16 updates the driving information related to the driver P1, and proceeds to S110. For example, the control unit 16 records, in a storage unit (not illustrated) in the control unit 16 for each driver, when and where driver P1 of vehicle 100 traveled, what kind of driving action the driver P1 was taken, were there any dangerous scene, what was the provided content and the like as driving information. In S100, updating and recording of adding the latest driving information to such driving information for each driver are performed.

In S110, the control unit 16 determines whether or not the driving is terminated. In a case where a predetermined terminating operation is performed, the control unit 16 makes an affirmative determination in S110 and terminates the processing according to FIG. 3. In a case where the terminating operation is not performed, the control unit 16 makes a negative determination in S110 and returns to S10. In the case of returning to S10, the control unit 16 repeats the above-described processing.

According to the embodiment described above, the following effects are obtained.

(1) An information providing apparatus 200 includes a vehicle sensor group 12 serving as a detection unit that detects a behavior of the vehicle 100, a control unit 16 serving as a recognition unit that recognizes the surrounding situation of the vehicle 100, a driver state estimation unit 161 that estimates a state of a driver P1 of the vehicle 100, an analysis unit 163 that analyzes a driving action of the driver P1 based on the behavior of the vehicle 100 detected by the vehicle sensor group 12, the surrounding situation recognized by the control unit 16, and the state of the driver P1 estimated by the driver state estimation unit 161, a determination unit 164 that determines whether the driving action analyzed by the analysis unit 163 corresponds to a first specific event in which a predetermined operation is performed on a driving operation member to avoid a danger predicted by the driver P1, or a second specific event in which a predetermined operation is performed on a driving operation member to avoid danger without the driver P1 making a prediction, a selection unit 165 that selects a second content according to a driving action analyzed by the analysis unit 163 in a case where the determination unit 164 determines that the driving action corresponds to the second specific event, and selects a first content according to a factor of the predetermined operation in a case where the determination unit 164 determines that the driving action corresponds to the first specific event, and a provision unit 166 that provides the first or second content selected by the selection unit 165 to the driver P1.

With such a configuration, since different contents are provided based on the analysis result including the state of the driver P1, it is possible to provide content serving as useful information for the driver P1.

For example, the awareness of the driver P1 greatly differs between a case where the driving action corresponds to a first specific event (sudden brake, etc.) not caused by the cognition and determination mistake of the driver P1 and a case where the driving action corresponds to a second specific event (sudden brake, etc.) caused by the cognition and determination mistake of the driver P1. Therefore, if the content of the danger prediction training is selected without distinguishing the two, the effect of the training is small for the driver P1 whose driving action corresponds to the first specific event (sudden brake, etc.) (in other words, cognition and determination were appropriate).

In the embodiment, for the driver P1 with appropriate cognition and determination, the overlapping of the content to be provided can be prevented, the effect of training by the content to be provided can be enhanced, and the acceptability of the driver P1 with respect to the danger prediction training can be improved by selecting the first content different from the case where there is cognition and determination mistake.

(2) In the information providing apparatus 200 of (1), when a predetermined operation on the driving operation member of the vehicle 100 is detected, the analysis unit 163 and the determination unit 164 start analysis and determination.

For example, since the operation is started by detection of a predetermined operation such as sudden brake operation or abrupt steering operation, it is easy to obtain the satisfaction of the driver P1 as compared with a case where the operation is started without being limited to the predetermined operation, and it is also possible to enhance the effect of training by the provided content.

(3) In the information providing apparatus 200 of (1), in a case where the driving action is determined to correspond to the first specific event, the selection unit 165 extracts an item to be trained from the driving action analyzed by the analysis unit 163, and selects, as the first content, content that is generated with a driving scene different from the driving scene at the time the extracted item is determined to correspond to the first specific event as a subject and has a common factor of the predetermined operation.

A dangerous scene similar to the dangerous scene actually experienced by the driver P1 is not intentionally adopted, and the first content that is generated using a dangerous scene different from the experienced dangerous scene and has a common factor of the predetermined operation (e.g., a blind spot of an intersection and a blind spot of a parking lot) is selected. The first content can cause the driver P1 to recall a similar near miss experience, and is expected to lead to a change in future driving action.

(4) In the information providing apparatus 200 of (3), in a case of selecting the first content, the selection unit 165 determines whether the predetermined operation is performed due to an internal factor or an external factor, and selects content having a common factor of the predetermined operation as the first content from among a plurality of pieces of content prepared in advance.

With this configuration, more suitable content can be provided to the driver P1 by dividing the predetermined operation into internal/external factors and further typifying and classifying these factors.

(5) In the information providing apparatus 200 of (1), the analysis unit 163 extracts near miss experiences from the driving action of the driver P1, and the determination unit 164 determines, as a first specific event, a sudden operation on a driving operation member that is not caused by cognition and determination mistake among the near miss experiences.

With this configuration, it is possible to distinguish whether the sudden operation for avoiding danger is an action (first specific event) after appropriately performing cognition and determination or an instantaneous action (second specific event) caused by cognition and determination mistake, and thus, it is possible to provide content appropriate for the driver P1.

(6) In the information providing apparatus 200 of (2), the driver state estimation unit 161 estimates the state of the driver P1 based on at least the information acquired by the vehicle interior camera 13, and the analysis unit 163 analyzes the driving action of the driver P1 based on the change in the state of the driver P1 estimated before and after the sudden operation on the driving operation member by the driver state estimation unit 161.

Since the change in state due to tension or surprise of the driver P1 who is driving is estimated on the basis of the image information of the vehicle interior camera 13, the near miss state can be accurately estimated. Note that the change in the state of the driver P1 may be estimated based on the voice of the driver P1 recorded at the timing an operation such as sudden brake is performed.

The above-described embodiments may be modified into various modes. Hereinafter, modified examples will be described.

### First Modified Example

In the above-described embodiment, the example in which the content of the danger prediction training for the driver P1 is provided by the information providing apparatus 200 for each vehicle 100 has been described, but the server device 400 of FIG. 1A connected to the vehicle 100 via the public communication network 300 may bear a part of the information providing processing performed for each vehicle 100.

For example, the storage capacity of the content storage unit 170 in each vehicle 100 can be suppressed by accessing the server device 400 from the vehicle 100 and selecting content at the time of selecting content.

In addition, information can be shared among the vehicles 100. As an example, by sharing the information regarding the dangerous scene between the vehicle 100A and the vehicle 100B, both drivers P1A and P1B can recall similar near miss experiences, and it is expected to lead to changes in the future driving actions of the drivers P1A and P1B.

### Second Modified Example

In the above description, an example has been described in which the driver P1 of the vehicle 100 who has received provision of the content of the danger prediction training views the content via the output device 50 of the vehicle 100. Alternatively, the in-vehicle device 14 may transmit content to the terminal 2A used by the driver P1 via the first communication unit 180, and the driver P1 may view the content reproduced on the terminal 2A. According to the second modified example, the driver P1 can view the content from the terminal 2A as a look-back of his/her own driving after getting off the vehicle 100.

The above embodiment can be combined as desired with one or more of the aforesaid modifications. The modifications can also be combined with one another.

According to the present invention, since different contents are provided based on the analysis result including the state of the driver, it becomes possible to provide content serving as useful information for the driver.

Above, while the present invention has been described with reference to the preferred embodiments thereof, it will be understood, by those skilled in the art, that various changes and modifications may be made thereto without departing from the scope of the appended claims.

1. An information providing apparatus, comprising:
a sensor configured to detect a behavior of a vehicle; and
an in-vehicle device including a processor and a memory coupled to the processor, wherein
the in-vehicle device is configured to perform:
recognizing a surrounding situation of the vehicle;
estimating a state of a driver of the vehicle;
analyzing a driving action of the driver based on the behavior of the vehicle, the surrounding situation, and the state of the driver;
determining whether the driving action corresponds to a first specific event in which a predetermined operation is performed on a driving operation member to avoid a danger predicted by the driver, or a second specific event in which the predetermined operation is performed on the driving operation member to avoid the danger without the driver making a prediction;
selecting a second content according to the driving action in a case where it is determined that the driving action corresponds to the second specific event, while selecting a first content according to a factor of the predetermined operation in a case where it is determined that the driving action corresponds to the first specific event; and
providing the first content or the second content to the driver.

2. The information providing apparatus according to claim 1, wherein
when the predetermined operation on the driving operation member of the vehicle is detected, the in-vehicle device starts the analyzing and the determining.

3. The information providing apparatus according to claim 1, wherein
when it is determined that the driving action corresponds to the first specific event, the in-vehicle device is configured to extract an item to be trained from the driving action, and select, as the first content, content that is generated with a driving scene different from a specific driving scene at a time when it is determined that the item corresponds to the first specific event as a subject and has a common factor of the predetermined operation.

4. The information providing apparatus according to claim 3, wherein
when selecting the first content, the in-vehicle device is configured to determine whether the predetermined operation is performed due to an internal factor or an external factor, and select content having a common factor of the predetermined operation as the first content from among a plurality of pieces of content prepared in advance.

5. The information providing apparatus according to claim 1, wherein
the in-vehicle device is configured to extract near miss experiences from the driving action of the driver and determine, as the first specific event, a sudden operation on the driving operation member that is not caused by cognition and determination mistake among the near miss experiences.

6. The information providing apparatus according to claim 2, wherein
the in-vehicle device is configured to estimate the state of the driver based on at least information acquired by a camera or a vital sensor, and analyze the driving action of the driver based on a change in the state of the driver estimated before and after a sudden operation on the driving operation member.
